(19) United States
(12) Patent Application Publication
(10) Pub. No.: US 2011/0270776 A1
(43) Pub. Date: Nov. 3, 2011

(54) METHOD AND SYSTEM FOR JUDICIAL COURT CASE MANAGEMENT

(76) Inventors: Robert H. Sprecher, Broomfield, CO (US); Marshall R. Bigelow, Stilwell, KS (US); Timothy P. Picraux, Warrington, PA (US); Mary Rose White, Chatham, NJ (US)

(21) Appl. No.: 13/094,251

(22) Filed: Apr. 26, 2011

Related U.S. Application Data
(60) Provisional application No. 61/329,245, filed on Apr. 29, 2010.

(51) Int. Cl. G06Q 10/00; G06Q 50/00

(52) U.S. Cl. 705/342

(57) ABSTRACT

A system, method and computing device for judicial court case management. According to an embodiment, the court case management method and system provides a component-based environment utilizing a library of reusable blueprinting artifacts and best practices templates in conjunction with server-based data management system and rules engine. The court case management system includes a user presentation layer configured to allow users to access and interact with the court case management system, a logical business layer configured to allow the court case management system to interact with external systems, a process control layer configured to govern the existence of data content within the court case management system and to manage at least one process that controls the data content within the court case management system, and a services and administration layer configured to provide security, compliance tracking and reporting to technology infrastructure to which the court case management system is installed.

### RELATED APPLICATION

This application claims the benefit of U.S. Provisional Patent Application Ser. No. 61/329,245, filed Apr. 29, 2010, entitled “UNISYS COURT CASE MANAGMENT” by Sprecher, et al. This application is incorporated in its entirety herein.

### FIELD

The instant disclosure relates generally to judicial system court case management, and more particularly, to system court case management systems and methods that are adaptable and customizable yet relatively stable and inexpensive.

### DESCRIPTION OF THE RELATED ART

Modern judicial systems rely relatively heavily upon automated case management systems for docketing, task assignment, tracking, intra-court communications, the coordination and distribution of documents and global project/case administration. There exist numerous conventional offerings in the market providing both “off-the-shelf” and fully customized solutions for this arena. Certain drawbacks are inherent in each of these conventional solutions. The conventional “off-the-shelf” solutions provide users with a case management product that can be relatively quickly installed and implemented. However, conventional “off-the-shelf” products typically are one-size-fits-all offerings that may provide all the needed functionality but will not provide an environment that can be adapted in response to evolving and changing requirements. In contrast, conventional fully customized solutions typically are tailored to meet present functionality requirements of a given judicial environment. However, conventional fully customized solutions are relatively expensive, require relatively significant time for design, installation and testing, and cannot be readily adapted to meet evolving and changing user requirements.

### SUMMARY

Disclosed is a method, system and computing device for judicial court case management. According to an embodiment, the judicial court case management method and system provides a component-based environment utilizing a library of reusable blueprinting artifacts and best practices templates in conjunction with server-based data management system and rules engine. Such combination results in a highly agile and adaptable court case management system and method. The inventive court case management system and method reduces the time required for design and implementation, while offering a system that can be customized to meet present needs within a given judicial environment and that can be relatively easily adapted to meet evolving and future requirements. The inventive court case management system and method allows users to modify capabilities and functionality without compromising stability and without incurring relatively significant expense and down-time. The court case management system includes a user presentation layer configured to allow users to access and interact with the court case management system, a logical business layer configured to allow the court case management system to interact with external systems, a process control layer configured to govern the existence of data content within the court case management system and to manage at least one process that controls the data content within the court case management system, and a services and administration layer configured to provide security, compliance tracking and reporting to technology infrastructure to which the court case management system is installed.

### BRIEF DESCRIPTION OF THE DRAWINGS

FIG. 1 is a schematic view of a court case management system according to an embodiment;

FIG. 2 is a schematic view of a data flow method within the court case management system according to an embodiment; and

FIG. 3 is a schematic view of an apparatus for court case management according to an embodiment.

### DETAILED DESCRIPTION

In the following description, like reference numerals indicate like components to enhance the understanding of the disclosed methods and systems through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

As used in this description, the terms “component,” “module,” and “system,” are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes, such as in accordance with a signal having one or more data packets, e.g., data from one component interacting with another component in a local system, distributed system, and/or across a network, such as the Internet, with other systems by way of the signal.

According to an embodiment, the judicial court case management method and system provides a component-based environment utilizing a library of reusable blueprinting artifacts and best practices templates in conjunction with server-based data management system and rules engine. Such combination results in a relatively agile and adaptable court case management system and method. The inventive court case management system and method reduces the time required for design and implementation, while offering a system that can be customized to meet present needs within a given judicial environment and that can be relatively easily adapted to meet evolving and future requirements.

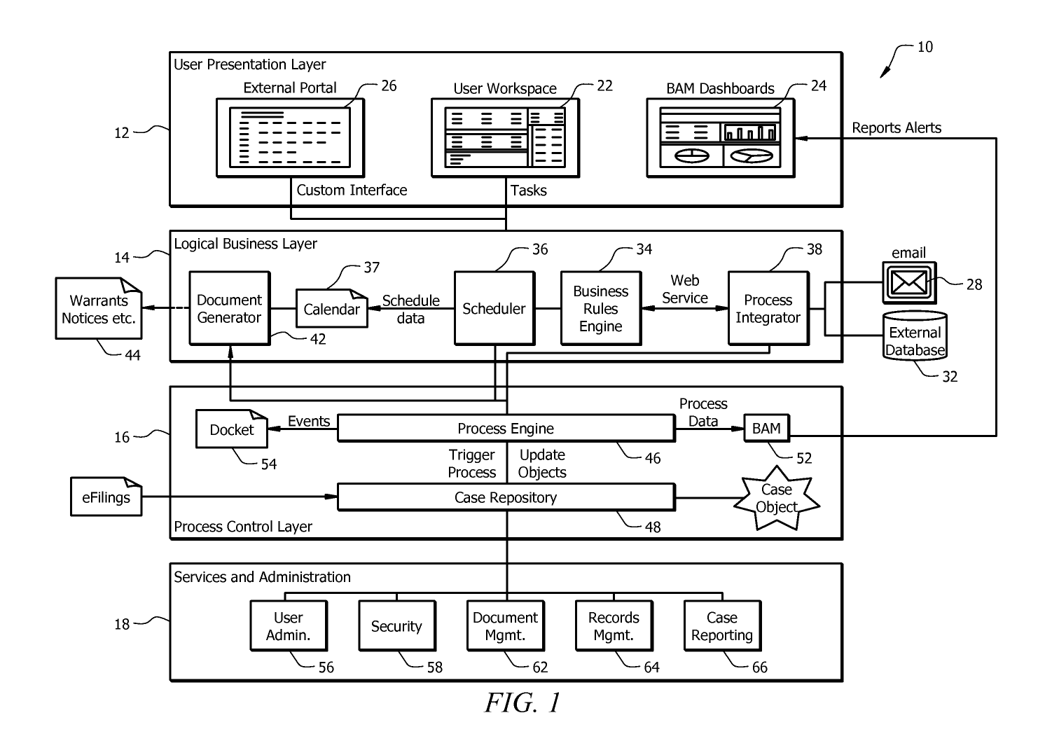

FIG. 1 is a schematic view of a court case management system 10 according to an embodiment. The system 10 includes a User Presentation Component or Layer 12, a Logical Business Component or Layer 14, a Process Control Component or Layer 16, and a Services and Administration Component or Layer 18.

According to an embodiment, the User Presentation Layer 12 provides access to user interfaces, authentication and navigation. The User Presentation Layer 12 includes three distinct components or elements. The User Presentation Layer 12 includes a User Workspace application 22, one or more Business Activity Monitor (BAM) Dashboard applications 24, and an External Portal application 26.

The User Workspace 22 includes a primary internal user interface for court staff and other appropriate users to interact with the court case management system 10. The user interface can be created using any suitable application toolkit or tool set. As shown, the User Workspace 22 communicates with the External Portal 26 and with the Logical Business Component Layer 14.

According to an embodiment, most reports generated by the court case management system 10 will be delivered through the User Workspace 22. However, the Business Activity Monitor (BAM) dashboards 24 collectively are an architecturally distinct presentation layer, which provides an executive view of the activities, reports and alerts, and which is called out as such in the logical architecture of the court case management system 10.

The External Portal 26 is a full-featured and leading open source portal application framework. The External Portal 26 is incorporated into the User Presentation Layer 12 and the court case management system 10 to demonstrate how access to the court case management system 10 from outside the firewall might be accomplished. As shown, the External Portal 26 communicates with the User Workspace 22 and with the Logical Business Layer 14.

The Logical Business Layer 14 includes the components that permit the configuration and integration of the court case management system 10 with other applications and systems, such as an email application or system 28 and/or an external database application 32. The Logical Business Layer 14 also includes the components that permit data content transformation or third party calendaring. Components in the Logical Business Layer 14 include a Business Rules Engine 34, a Scheduler 36, a Process Integrator 38 and a Document Generator 42.

The Business Rules Engine 34 is used to abstract business rules from the rest of the application functionality to permit greater deployment flexibility.

The Scheduler 36 includes a scheduling interface that interacts with a calendar 37, which can be a third party calendaring process. The Scheduler 36 can be a complex process that may be better served using a specialized product set, but can be a rudimentary scheduling interface as well. As shown, the Scheduler 36 also communicates with the Process Control Layer 16.

The Process Integrator 38 works with a process engine (discussed in greater detail hereinbelow) in the Process Control Layer 16, and with a content server coupled to the court case management system 10 to deliver a universal integration service. The Process Integrator 38 allows users of the court case management system 10 to gain integration of process, data content, and repository services with external processes through a service-oriented architecture (SOA) implementation.

The Document Generator 42 generates appropriate documents 44 for the court case management system 10, such as warrants, notices and other suitable court case management documents.

The Process Control Layer 16 governs the existence of the data content to monitor and process appropriately, and the management of the business processes that control the data content. The Process Control Layer 16 includes a Process Engine component 46, a case content repository component 48, and one or more Business Activity Monitor (BAM) Dashboards 52.

The Process Engine 46 carries out the execution, orchestration, and management of business processes. According to an embodiment, the Process Engine 46 automatically evaluates business rules and assigns process tasks to the correct system, group, or individual at the appropriate time. Users of the court case management system 10 can interact with the Process Engine 46 through a set of interfaces that control and provide context for tasks, work lists, escalations, and notifications. As shown, the Process Engine 46 interacts with a docket 54 and transmits and receives docket events therebetween.

The Content Repository 48 provides a unified repository capable of storing and managing various types of data content, including documents, efilings, scanned images, Web pages, XML, rich media, records, engineering drawings, reports, and other appropriate content. The Content Repository 48 has a unique object-relational architecture, which will support an unlimited amount of object types, and therefore can store and manage a virtually unlimited number of objects of any type. This object storage and management ability enables organizations to leverage relatively sophisticated architectures and storage systems for their performance, geographic distribution, business continuity, globalization, and security requirements. The Content Repository 48 allows organizations to benefit from improved security, scalability, flexibility, and business continuity capabilities compared to conventional court case management systems.

The Business Activity Monitor (BAM) Dashboards 52 provide users of the court case management system 10 with real-time alerts, dashboards, and reports, thus making it relatively easy to access process execution data that is pulled directly from the Process Engine 46. The BAM Dashboards 52 track defined key performance indicators (KPIs), reports on process performance, and provides alerts on conditions that fall outside of designated thresholds.

The Services and Administration Layer 18 includes the supporting process and components for security or compliance tracking, as well as reporting that is common to technology infrastructure where the court case management system 10 is installed. The Services and Administration Layer 18 includes a user administration component 56, a security component 58, a document management component 62, a records management component 64 and a case reporting component 66.

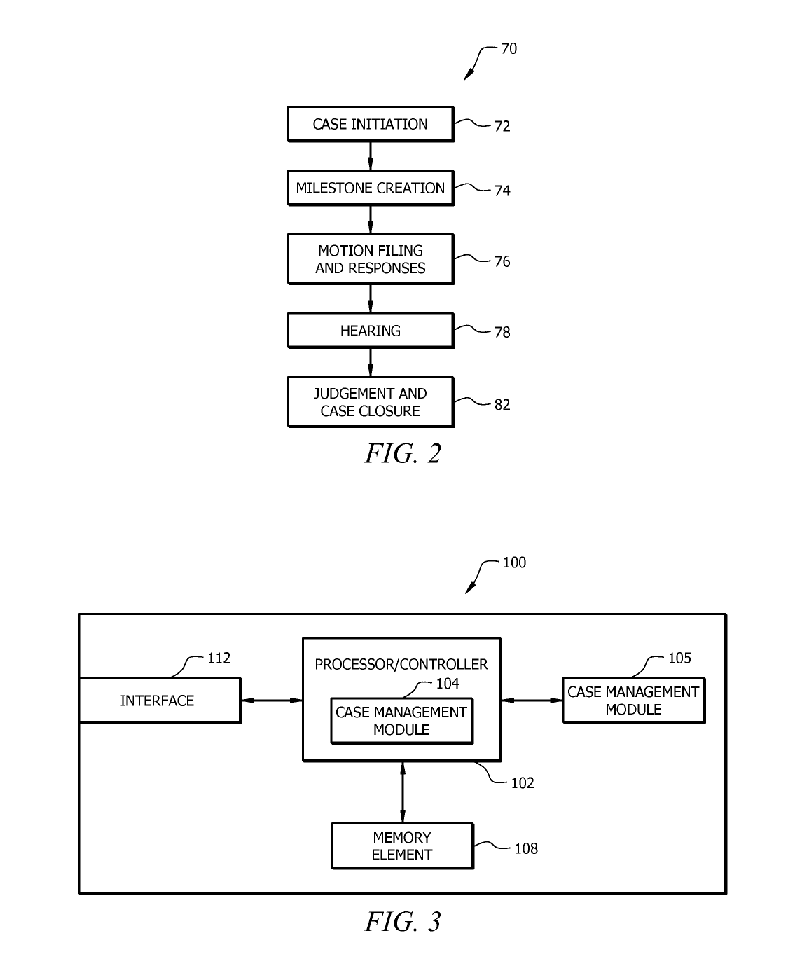

FIG. 2 is a schematic view of data flow or a data flow method 70 within the court case management system 10, according to an embodiment. The data flow method 70 includes a step 72 of case initiation. The case initiation step 72 typically begins with an external user logging in to the External Portal application 26. The user then creates and/or uploads a complaint form and submits the complaint formed when completed. The court case management system 10 receives the complaint and any attachments that may be included with the completed complaint. The court case management system 10 then creates a case folder from a template, initializes a case number and other appropriate case identification to be associated with the submitted complaint, as well as a case summary. The court case management system 10 then queues the case folder for data entry and validation. Once the case folder has been queued, a clerk validates the submitted form and assigns the correct court, jurisdiction, location, and judicial officer by editing the case form as appropriate. The clerk then creates participant and party records as needed. The court case management system 10 updates the case folder with the entered data, and moves the case folder to the correct folder location in the Content Repository 48. Once the updated case folder has been moved to the correct folder location in the Content Repository 48, the docket entry portion of the court case management system 10 is called.

The data flow method 70 also includes a step 74 of milestone creation. The milestone creation step 74 typically begins with an external user logging in to the External Portal application 26. A clerk manually initiates a milestone workflow on the complaint, including identifying the defendant and the attorney as notification recipients. The docket entry portion of the court case management system 10 is called. The court case management system 10 then sends an email to the attorney and the defendant, creates a timer, and then listens for events. When the attorney files a response to the complaint, the docket entry portion of the court case management system 10 is called. The court case management system 10 updates the milestone workflow with the appropriate expected event. The milestone then is flagged as completed.

The data flow method 70 also includes a step 76 of motion filing and response. The motion filing and response step 76 typically begins with a filing clerk receiving a scanned motion to dismiss the case. The court case management system 10 then initiates a filing workflow, attaches the documents, and sets any metadata associated with the document. Because of the document type, a milestone workflow is created to track the response. The filing workflow then sends a notification to the other party that notice has been given. The timer on the milestone workflow waits for a response from the attorney of the other party.

The data flow method 70 also includes a hearing step 78. The hearing step 78 typically begins with a filing clerk initiating a hearing workflow for the appropriate case. When a scheduling clerk sees the task on queue, the scheduling clerk creates a schedule item for the hearing, sets a hearing date for the case and forwards the workflow. On the hearing date, the workflow is forwarded to a disposition clerk to record the outcome of the hearing. The court case management system 10 ensures that all parties to the case have a disposition record, and the case is forwarded. The case appears in the queue of the file clerk for closure.

The data flow method 70 also includes a step 82 of judgment/case closure. The judgment/case closure step 82 typically begins when the disposition clerk receives the judgment of the case. The disposition clerk then submits the judgment to a “close and archive” queue. The court case management system 10 then validates the disposition of all parties to the case, and applies adjudication to the case. The case then is set to “closed,” and moved to an appropriate archive location within the court case management system 10.

According to an embodiment, the court case management system 10 provides a case monitoring process that tracks the top level state of each case for reporting and dashboarding purposes. As discussed hereinabove, the monitoring process generates a unique case number based on the supplied case type and filed date. Also, customizations to the numbering scheme can be encapsulated within this process and made relatively easy to configure.

According to an embodiment, the court case management system 10 also provides a case initiation process, which manages the new case ingest queue. The court case management system 10 receives messages from the External Portal application 26, e.g., via HTTP post listeners, and an initial case folder and template object is created, e.g., based on the receipt of appropriate message. A case worker completes any associated metadata and initiates other processes as needed, e.g., milestones and hearings. The case initiation process makes use of the docket and notification process.

According to an embodiment, the court case management system 10 also provides a process for new case filings. The new case filing process manages the addition of files to an existing case. The new case filing process implements the storage of content into the proper location, document sequence number generation, metadata enforcement and notifications. The new case filing process also can invoke the notification, hearing and docket processes.

According to an embodiment, the court case management system 10 also provides a case hearing process. The case hearing process creates a scheduled item representing a hearing for a particular case. The hearing purpose, case identification, and required participants are supplied to the created scheduled item.

According to an embodiment, the court case management system 10 also provides a case milestone process. The case milestone process provides milestone tracking for a particular case. The case milestone process is supplied with a milestone description, limit, callback identification and other appropriate information.

According to an embodiment, the court case management system 10 also provides a docket entry process. The docket entry process is a utility process performed by the court case management system 10 (i.e., no human interaction) that generates one or more docket entries to the appropriate folder of a specific case.

According to an embodiment, the court case management system 10 also provides a party notification process. The party notification process is a utility process that sends email or other appropriate form of notification to all case participants.

FIG. 3 is a schematic view of an apparatus 100 for judicial system court case management according to an embodiment. The apparatus 100 can be any apparatus, device or computing environment suitable for providing a judicial court case management system according to an embodiment. For example, the apparatus 100 can be or be contained within any suitable computer system, including a mainframe computer and/or a general or special purpose computer.

The apparatus 100 includes one or more general purpose (host) controllers or processors 102 that, in general, processes instructions, data and other information received by the apparatus 100. The processor 102 also manages the movement of various instructional or informational flows between various components within the apparatus 100. The processor 102 can include a court case management module 104 that is configured to execute and perform the court case management processes described herein. Alternatively, the apparatus 100 can include a standalone court case management module 105 coupled to the processor 102.

The apparatus 100 also can include a memory element or content storage element 108, coupled to the processor 102, for storing instructions, data and other information received and/or created by the apparatus 100. In addition to the memory element 108, the apparatus 100 can include at least one type of memory or memory unit (not shown) within the processor 102 for storing processing instructions and/or information received and/or created by the apparatus 100.

The apparatus 100 also can include one or more interfaces 112 for receiving instructions, imagery, data and other information. It should be understood that the interface 112 can be a single input/output interface, or the apparatus 100 can include separate input and output interfaces.

One or more of the processor 102, the court case management module 104, the court case management module 105, the memory element 108 and the interface 112 can be comprised partially or completely of any suitable structure or arrangement, e.g., one or more integrated circuits. Also, it should be understood that the apparatus 100 includes other components, hardware and software (not shown) that are used for the operation of other features and functions of the apparatus 100 not specifically described herein.

The apparatus 100 can be partially or completely configured in the form of hardware circuitry and/or other hardware components within a larger device or group of components. Alternatively, the processes performed by the apparatus 100 can be partially or completely configured in the form of software, e.g., as processing instructions and/or one or more sets of logic or computer code. In such configuration, the logic or processing instructions typically are stored in a data storage device, e.g., the memory element 108 or other suitable data storage device (not shown). The data storage device typically is coupled to a processor or controller, e.g., the processor 102. The processor accesses the necessary instructions from the data storage element and executes the instructions or transfers the instructions to the appropriate location within the apparatus 100.

One or more of the court case management module 104 and the court case management module 105 can be implemented in software, hardware, firmware, or any combination thereof. In certain embodiments, the module(s) may be implemented in software or firmware that is stored in a memory and/or associated components and that are executed by the processor 102, or any other processor(s) or suitable instruction execution system. In software or firmware embodiments, the logic may be written in any suitable computer language. One of ordinary skill in the art will appreciate that any process or method descriptions associated with the operation of the court case management module 104 and the court case management module 105 may represent modules, segments, logic or portions of code which include one or more executable instructions for implementing logical functions or steps in the process. It should be further appreciated that any logical functions may be executed out of order from that described, including substantially concurrently or in reverse order, depending on the functionality involved, as would be understood by those reasonably skilled in the art. Furthermore, the modules may be embodied in any non-transitory computer readable medium for use by or in connection with an instruction execution system, apparatus, or device, such as a computer-based system, processor-containing system, or other system that can fetch the instructions from the instruction execution system, apparatus, or device and execute the instructions.

The functions described may be implemented in hardware, software, firmware, or any combination thereof. If implemented in software, the functions may be stored on or transmitted as one or more instructions or code on a non-transitory computer-readable medium. The methods illustrated in the figures may be implemented in a general, multi-purpose or single purpose processor. Such a processor will execute instructions, either at the assembly, compiled or machine-level, to perform that process. Those instructions can be written by one of ordinary skill in the art following the description of the figures and stored or transmitted on a non-transitory computer readable medium. The instructions may also be created using source code or any other known computer-aided design tool. A non-transitory computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents.

1. A court case management system, comprising:
a user presentation layer configured to allow users to access and interact with the court case management system;
a logical business layer configured to allow the court case management system to interact with external systems;
a process control layer configured to govern the existence of data content within the court case management system and to manage at least one process that controls the data content within the court case management system; and
a services and administration layer configured to provide security, compliance tracking and reporting to technology infrastructure to which the court case management system is installed.

2. The system as recited in claim 1, wherein the user presentation layer includes
a user workspace that includes an internal user interface configured to allow users to interact with the court case management system,
at least one business activity monitor (BAM) dashboard configured to provide users with court case management alerts, dashboards and reports, and
an external portal that provides access to the court case management system from outside of a firewall securing the court case management system.

3. The system as recited in claim 1, wherein the logical business layer includes
a business rules engine configured to abstract business rules from other locations within the court case management system in such a way that provides greater flexibility to the deployment of the processes within the court case management system,
a scheduler configured to interact with a calendar coupled to the court case management system,
a process integrator configured to integrate the process, data content and repository services of the process control layer, and
a document generator configured to generate court case documents.

4. The system as recited in claim 1, wherein the logical business layer is configured to allow the court case management system to interact with at least one of an external email application and an external database application.

5. The system as recited in claim 1, wherein the logical business layer is configured to transform data content received by the court case management system.

6. The system as recited in claim 1, wherein the process control layer includes
a process engine configured to assign, based on an evaluation of business rules, process tasks to the proper component within the court case management system,
a case repository configured to store and manage data content used by the court case management system, and
at least one business activity monitor (BAM) dashboard configured to provide users with at least one of court case management alerts, dashboards and reports.

7. The system as recited in claim 1, wherein the process control layer includes a case repository having an object-relational architecture configuration.

8. The system as recited in claim 1, wherein the services and administration layer includes
a user administration component,
a security component,
a document management component,
a records management component, and
a case reporting component.

9. The system as recited in claim 1, wherein the data content includes at least one of documents, efilings, scanned images, Web pages, XML, rich media, records, engineering drawings, and reports.

10. A computing device, comprising:
a processor;
a memory element coupled to the processor; and
a case management module coupled to the processor and to the memory element, wherein the case management module includes
a user presentation layer configured to allow users to access and interact with the court case management system,
a logical business layer configured to allow the court case management system to interact with external systems,
a process control layer configured to govern the existence of data content within the court case management system and to manage at least one process that controls the data content within the court case management system, and
a services and administration layer configured to provide security, compliance tracking and reporting to technology infrastructure to which the court case management system is installed.

11. The computing device as recited in claim 10, wherein the user presentation layer includes
a user workspace that includes an internal user interface configured to allow users to interact with the court case management system,
at least one business activity monitor (BAM) dashboard configured to provide users with court case management alerts, dashboards and reports, and
an external portal that provides access to the court case management system from outside of a firewall securing the court case management system.

12. The computing device as recited in claim 10, wherein the logical business layer includes
a business rules engine configured to abstract business rules from other locations within the court case management system in such a way that provides greater flexibility to the deployment of the processes within the court case management system,
a scheduler configured to interact with a calendar coupled to the court case management system,
a process integrator configured to integrate the process, data content and repository services of the process control layer, and
a document generator configured to generate court case documents.

13. The computing device as recited in claim 10, wherein the logical business layer is configured to allow the court case management system to interact with at least one of an external email application and an external database application.

14. The computing device as recited in claim 10, wherein the logical business layer is configured to transform data content received by the court case management system.

15. The computing device as recited in claim 10, wherein the process control layer includes
a process engine configured to assign, based on an evaluation of business rules, process tasks to the proper component within the court case management system,
a case repository configured to store and manage data content used by the court case management system, and
at least one business activity monitor (BAM) dashboard configured to provide users with at least one of court case management alerts, dashboards and reports.

16. The computing device as recited in claim 10, wherein the process control layer includes a case repository having an object-relational architecture configuration.

17. The computing device as recited in claim 10, wherein the services and administration layer includes
a user administration component,
a security component,
a document management component,
a records management component, and
a case reporting component.

18. A non-transitory computer readable medium having instructions stored thereon which, when executed by a processor, carry out a method for court case management, the instructions comprising:
user presentation layer instructions to allow users to access and interact with the court case management system;
logical business layer instructions to allow the court case management system to interact with external systems;
process control layer instructions to govern the existence of data content within the court case management system and to manage at least one process that controls the data content within the court case management system; and
services and administration layer instructions to provide security, compliance tracking and reporting to technology infrastructure to which the court case management system is installed.

19. The non-transitory computer readable medium as recited in claim 18, wherein the user presentation layer includes
user interface instructions to allow users to interact with the court case management system,
business activity monitor (BAM) dashboard instructions to provide users with court case management alerts, dashboards and reports, and
external portal instructions that provides access to the court case management system from outside of a firewall securing the court case management system.

20. The non-transitory computer readable medium as recited in claim 18, wherein the logical business layer includes
business rules engine instructions to abstract business rules from other locations within the court case management system in such a way that provides greater flexibility to the deployment of the processes within the court case management system,
scheduler instructions to interact with a calendar coupled to the court case management system,
process integrator instructions to integrate the process, data content and repository services of the process control layer, and
document generator instructions to generate court case documents.
